(19) United States
(12) Patent Application Publication
(10) Pub. No.: US 2026/0330469 A1
(43) Pub. Date: Oct. 22, 2026

(54) REAL TIME INFRASTRUCTURE DISTURBANCE RESPONSE TOOL

(71) Applicant: Texas Excavation Safety System, Inc. d/b/a Texas811, Richardson, TX (US)

(72) Inventors: Thomas Kyle VanLandingham, Dallas, TX (US); Alecia Sims Helton, Dallas, TX (US); Sarah Etoyle McTee, Blue Ridge, TX (US); Arron D. Mitchell, Allen, TX (US)

(21) Appl. No.: 19/180,875

(22) Filed: Apr. 16, 2025

(51) Int. Cl. G06Q 30/015; G06Q 10/063; G06Q 50/06

(52) U.S. Cl. CPC G06Q 30/015; G06Q 10/063; G06Q 10/20; G06Q 50/06

(57) ABSTRACT

An infrastructure disturbance reporting tool includes a network interface and an assessment engine. The assessment engine configured to receive notifications indicating a detected disturbance and a corresponding location. The assessment engine is configured to receive, from the external system, a first notification indicating a first location, and issue a first query to the one or more databases to identify a ticket of interest based at least on the first location and a date of the first notification. The assessment engine is further configured to identify an area of interest and identify at least a first utility within the area of interest. The assessment engine is also configured to generate a response directed to a contact associated with each identified utility upon determining that the first query did not identify the ticket of interest.

### TECHNICAL FIELD

This invention relates generally to the field of detecting and responding to disturbances near underground utility infrastructure.

### BACKGROUND

Utilities, such as water lines, gas lines, electrical lines, and internet lines, are often buried underground and inherently risk being damaged by excavation. Historically, damage prevention efforts in the utility industry have focused on damage awareness rather than intervention because of the general inability to detect utility damage before it occurs. To that end, individuals and entities are required by law to contact their local 811 center before beginning an excavation project to request that buried utilities be located and/or marked to prevent potential damage. The 811 center may in turn contact owners and/or affiliates of utilities positioned near the reported job site to verify and mark the location of at-risk infrastructure.

One challenge with this conventional prevention method is that it requires individuals and entities to contact their local 811 centers prior to starting an excavation project. Reliance on the individuals or entities to contact their local 811 center can cause many issues since they may fail to contact their local 811 center for any number of reasons. For example, an individual may fail to contact their local 811 center because they forget, cannot wait to begin their project, are unfamiliar or unaware of nearby utilities/regulations requiring 811 contact, or are otherwise unable to make contact. Without the benefit of utility marking, the potential for utility damage increases significantly, and may result in disruption to utility services, environmental damage, repair and cleanup costs, and/or serious injury or death (due to e.g., release of toxic substances, fire, explosions), in addition to monetary fines and costs.

### SUMMARY

In one embodiment, an infrastructure disturbance reporting tool includes a network interface and an assessment engine. The network interface is configured to receive one or more notifications from an external system, each notification indicating a detected utility disturbance and a corresponding location. The assessment engine is executable by at least one processor and is communicatively coupled to one or more databases configured to store data about a plurality of tickets and a plurality of utilities. The assessment engine is configured to receive, from the external system, a first notification indicating a first location, and issue a first query to the one or more databases to identify a ticket of interest based at least on the first location and a date of the first notification. The assessment engine is further configured to identify an area of interest based on the first location and issue a second query to the one or more databases to identify at least a first utility within the area of interest. The assessment engine is also configured to generate a response directed to a contact associated with each identified utility upon determining that the first query did not identify the ticket of interest or that the ticket of interest indicates a disturbance type that does not correspond to the detected utility disturbance of the first notification.

In some embodiments, a method for responding to infrastructure disturbances includes receiving a first notification indicating a first detected utility disturbance and a first location corresponding to the first detected utility disturbance from an external system communicatively coupled to one or more databases configured to store data about a plurality of tickets and a plurality of utilities each corresponding to a unique reference identifier. The method may further include issuing a first query to one or more databases to identify a ticket of interest based at least on the first location and a date of the first notification and identifying an area of interest based on the first location. The method may further include issuing a second query to the one or more databases to identify at least a first utility within the area of interest. The method may further include generating a response directed to a contact associated with each identified utility upon determining that the first query did not identify the ticket of interest, or that the ticket of interest indicates a disturbance type that does not correspond to the first detected utility disturbance of the first notification.

Some embodiments may include one or more computer readable non-transitory storage media embodying software that is operable when executed by at least one processor of an assessment engine communicatively coupled to one or more databases configured to store data about a plurality of tickets and a plurality of utilities each corresponding to a unique reference identifier. The software is further configured to receive, from an external system, a first notification indicating a first detected utility disturbance and a first location corresponding to the first detected utility disturbance. The software is further configured to issue a first query to the one or more databases to identify a ticket of interest based at least on the first location and a date of the first notification. The software is further configured to identify an area of interest based on the first location, issue a second query to the one or more databases to identify at least a first utility within the area of interest, issue a second query to the one or more databases to identify at least a first utility within the area of interest. The software is further configured to generate a response directed to a contact associated with each identified utility upon determining that the first query did not identify the ticket of interest or that the ticket of interest indicates a disturbance type that does not correspond to the detected utility disturbance of the first notification.

Certain embodiments may provide one or more technical advantages. For example, an embodiment of this disclosure provides a system capable of detecting and reporting, in real time, unknown or unauthorized excavation. This proactive damage prevention solution may reduce and/or eliminate the costs associated with damaging utility infrastructure, including the costs of customer service downtime, monetary costs associated with repair and remediation, environmental harm, and bodily injury or death. As another example, embodiments described herein may facilitate a real-time response that confirms and/or mitigates damage caused by detected excavation, such as alerting interested persons (e.g., utility operators, affected community members), deploying resources (e.g., unmanned aerial vehicles) to the location of the detected excavation, and deactivating, disabling or discontinuing utility service along a damaged portion of a utility line. As another example, embodiments described herein may alert or otherwise notify persons and/or entities about potentially harmful or damaging utility disturbances that would not otherwise be notified using conventional solutions. This may include notifying, in real-time, property owners, utility recipients, government agencies, and media reporters within an area negatively affected or impacted by a detected disturbance.

### BRIEF DESCRIPTION OF THE DRAWINGS

FIG. 1 illustrates an exemplary system deploying an infrastructure disturbance reporting tool, according to certain embodiments.

FIG. 2 illustrates a method for providing real-time responses to detected disturbances, according to certain embodiments.

FIG. 3 illustrates an exemplary map depicting an area of interest identified by the infrastructure disturbance reporting tool of FIG. 1.

FIG. 4 is a block diagram illustrating a computer system configured to implement the method of FIG. 2, according to some embodiments.

### DETAILED DESCRIPTION

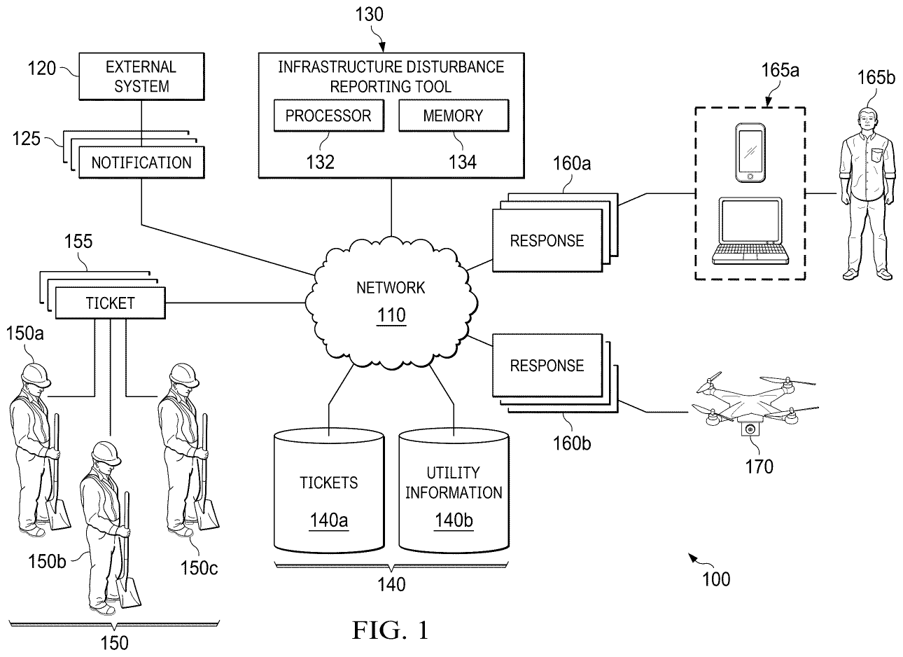

Embodiments of the present disclosure and its advantages may be understood by referring to FIGS. 1 through 4 of the drawings, like numerals being used for like and corresponding parts of the various drawings.

Generally, this disclosure contemplates an infrastructure disturbance reporting tool configured to predict, in real time, whether infrastructure disturbances are likely to result in damage or destruction of underground utilities and/or jeopardize the health and safety of impacted communities. Upon determining that a detected infrastructure disturbance presents an actual or potential damage or safety risk, infrastructure disturbance reporting tool is further configured to issue a custom response to, for, or on behalf of affected individuals to confirm, mitigate, or eliminate the risk. Accordingly, embodiments of an infrastructure disturbance reporting tool as provided herein may reduce the incidence of utility damage, which may in turn result in increased reliability of services provided by utilities, reduced repair and cleanup costs, and increased wellness and safety as compared to conventional methods of utility damage prevention.

FIG. 1 illustrates exemplary system 100 deploying an infrastructure disturbance reporting tool, according to certain embodiments. System 100 includes, inter alia, at least one network 110, external system 120, infrastructure disturbance reporting tool 130, one or more databases 140, and responses 160. As will be explained in further detail below, in response to receiving a notification 125 from external system 120, infrastructure disturbance reporting tool 130 determines whether a detected infrastructure disturbance presents a damage or safety risk based on excavation project data (stored as tickets 155) and utility information stored in one or more databases 140. If a determination is made that a damage or safety risk exists, infrastructure disturbance reporting tool 130 generates a response 160 to a contact (e.g., operator 165b, unmanned aerial vehicle (“UAV”) 170) associated with each utility operator affected by the detected infrastructure disturbance.

Network 110 is configured to facilitate communication between and amongst components of system 100. This disclosure contemplates network 110 being any suitable network operable to facilitate communication between the components of system 100. For example, network 110 may permit potential and actual excavators 150 to send requests 180 over network 110. Network 110 may include any interconnecting system capable of transmitting audio, video, signals, data, messages, or any combination of the preceding. Network 110 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. As depicted, system 100 includes one network-network 110. In other embodiments, however, system 100 includes a plurality of networks 110. In such an example, a first network 110 may be used for transmitting ticket 155 and a separate network 110 may facilitate transmission of notification 125 from external system 120.

External system 120 represents any suitable system configured to detect and report disturbances to infrastructure, including underground utilities. External system 120 may further be configured to make determinations or predictions about each detected disturbance, such as identifying a location corresponding to the detected disturbance and/or classifying the disturbance according to observed conditions, such as whether equipment contributed to the detected disturbance. External system 120 may be configured to make further determinations about detected infrastructure disturbances. As a nonlimiting example, external system 120 may be configured to determine the approximate depth of infrastructure disturbances (e.g., distance from ground level or from utility line) and provide such information in notification 125.

External system 120 may process detected disturbance information by one or more computers and incorporate the information (raw or processed), in whole or in part, in notifications 125 communicated over network 110. This disclosure specifically recognizes that external system 120 is configured to generate a notification 125 (or other communication) that indicates information about one or more detected disturbances, including a location indication and disturbance classification for each detected infrastructure disturbance. As an example, notifications 125 generated by external system 120 may comprise information indicating the location of a detected infrastructure disturbance (e.g., an address, a GPS coordinate, or a range of GPS coordinates), depth of the disturbance, time of the disturbance, and disturbance type In some embodiments, the disturbance type included in notifications 125 by external system 120 may include digging classifications/types such as hand excavation (e.g., shoveling) or machine excavation (e.g., backhoe digging), and may further include hazard types such as a leak in a utility pipe.

In some embodiments, external system 120 implements fiber optic sensing technology, which threads fiber optic cable through or near (e.g., within 30 yards) utility lines and is capable of sensing changes in strain, temperature, vibration, and acoustic signals, enabling the detection of disturbances and classification of activities such as excavation, pipeline leaks, secure facility intrusion, manhole manipulation, and other general disturbances with positional accuracy. For example, a fiber optic sensing system may sense an infrastructure disturbance at a particular position along a utility line and determine a GPS coordinate associated with the disturbance, as well as classifying the disturbance type as, e.g., mechanical digging.

In other embodiments, external system 120 uses or includes aerial patrol configured to detect and report ground disturbances. In such systems, one or more aerial vehicles, including UAVs, may be deployed to monitor excavation activities within a designated area. Upon detecting such activity, the one or more aerial vehicles and/or computer(s) communicatively coupled thereto may determine information about the detected activity, including a location corresponding to the detected excavation activity and/or a classification of the excavation activity. This information may then be relayed over network 110, e.g., in the form of notification 125, to infrastructure disturbance reporting tool 130.

Although this disclosure identifies particular technologies capable of sensing/detecting infrastructure disturbances, this disclosure recognizes that external system 120 may include or be any suitable technology capable of sensing/detecting infrastructure disturbances. For example, infrastructure disturbances may be detected or otherwise sensed by seismometers or accelerometers. In yet other embodiments, infrastructure disturbances are detected or otherwise sensed by surveillance cameras or other imaging devices (e.g., satellite imaging, security camera, drone footage, etc.).

As explained above, system 100 includes infrastructure disturbance reporting tool 130. Infrastructure disturbance reporting tool 130 is configured to receive one or more notifications 125 from external system 120 and determine whether to inform interested parties 165b about detected infrastructure disturbances. Accordingly, infrastructure disturbance reporting tool 130 may be connected to one or more networks 110, enabling it to communicate with at least external system 120, interested parties 165b, and devices, such as computers 165a and UAVs 170. As will be described in more detail below, infrastructure disturbance reporting tool 130 is also able to access information stored in one or more databases 140 relating to anticipated excavations and utility lines.

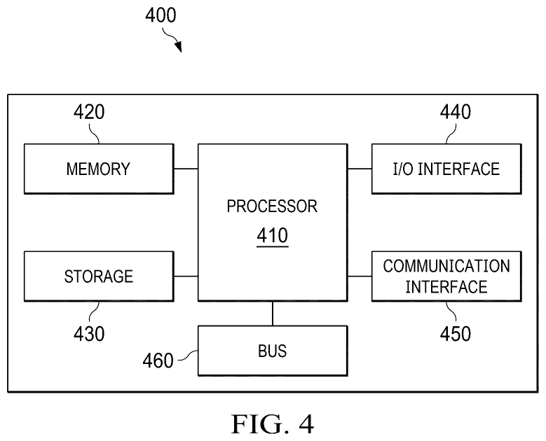

As illustrated in FIG. 1, infrastructure disturbance reporting tool 130 comprises a processor 132 and a memory 134. Processor 132 may be configured to execute various algorithms implemented by various modules of infrastructure disturbance reporting tool 130, such as a network interface configured to receive notifications 125 from external system 120 and an assessment engine configured to determine whether to generate responses to detected infrastructure disturbances. In some embodiments, infrastructure disturbance reporting tool 130 may be a program executed by a computer system. As an example, infrastructure disturbance reporting tool 130 may be executed by a computer such as computer 400 described below in reference to FIG. 4. In such an example, memory 134 may be memory 420 and processor 132 may be processor 410 of computer 400.

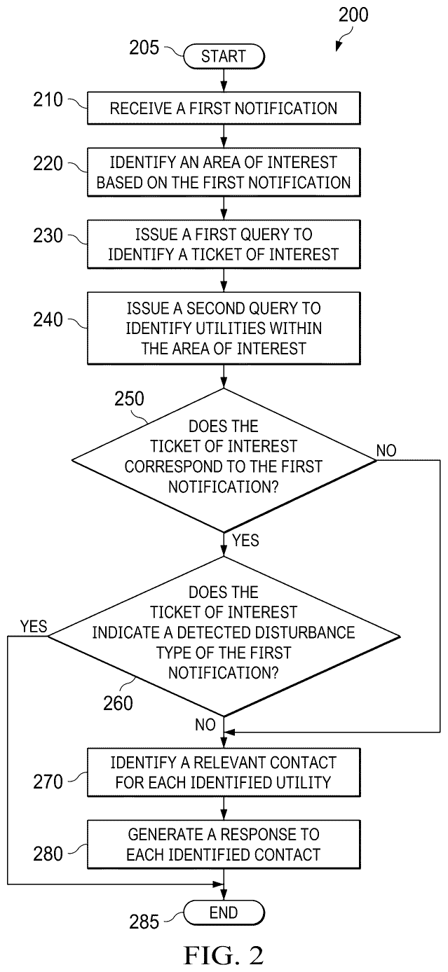

Infrastructure disturbance reporting tool 130 may use any information provided to it or retrieved by it to cause network 110 to send responses 160. For example, infrastructure disturbance reporting tool 130 may receive one or more notifications 125 via network 110, prompting it to initiate a plurality of queries to database(s) 140 to determine to inform interested parties 165b about detected infrastructure disturbances. As will be described in detail with respect to FIG. 2, infrastructure disturbance reporting tool 130 may generate response 160 when it determines, e.g., that a detected infrastructure disturbance is likely to result in infrastructure damage or presents a safety hazard.

In some embodiments, infrastructure disturbance reporting tool 130 is further configured to communicate with devices associated with a particular utility operator, enabling infrastructure disturbance reporting infrastructure disturbance reporting tool 130 to request and/or receive, e.g., via network 110, real time location data from each device. Infrastructure disturbance reporting tool 130 may then use the received location data to determine which of the devices to send response 160a to, e.g., the device indicating a location nearest to the detected disturbance location. In some embodiments, infrastructure disturbance reporting tool 130 may send response 160a to one or more of the affiliated devices, e.g., if infrastructure disturbance reporting tool 130 does not receive an acknowledgement of response 160a from a particular device 165b or particular interested party 165a within a particular time frame (e.g., 5 minutes). In some embodiments, response 160 generated by infrastructure disturbance reporting tool 130 may include a map that illustrates, inter alia, a detected disturbance location relative to the location of surrounding underground infrastructure. Infrastructure disturbance reporting tool 130 may then use previously received location data or request updated location data from one or more other affiliated devices and identify a second affiliated device to send response 160a to. Selection of the second affiliated device may or may not be based on the reported location data.

In some embodiments, system 100 includes one or more databases 140. As illustrated in FIG. 1, system 100 includes two databases—ticket database 140a and utility information database 140b—that are external to infrastructure disturbance reporting tool 130. In other embodiments, infrastructure disturbance reporting tool 130 includes database(s) 140. In either configuration, infrastructure disturbance reporting tool 130 (or subcomponents thereof) is communicatively coupled to database(s) 140.

Ticket database 140a is configured to store tickets 155 (or alternatively, information included in tickets 155), which each include or indicate information relayed by excavator(s) 150 about an excavation project. An exemplary ticket is provided below, indicating a location for the anticipated excavation and other related details:

Ticket Identifier: 000001

| | | |
|---|---|---|
| Anticipated Work Date: | Anticipated Work | Anticipated Work |
| Apr. 1, 2025 | Duration: | Type/Equipment: |
| | 2 days | Auger, Hand Tools, Shovel |
| Excavation Depth: | Excavation Length: | Excavation Location: |
| 16″+ | 4 feet | 12345 Excavation Lane |
| | | Dig, Texas 77777 |

NOTES:
Beginning work at the north property line and extending through the property to 10 ft from south property line, and from the east property line west for 20 ft, locate all utilities in work area.

As illustrated above, the excavation location may be stored in ticket database 140a as an address. In other embodiments, the excavation location may be stored as a GPS coordinate or a range of GPS coordinates. This disclosure recognizes that any suitable location indicator may be used to designate an excavation location.

Although this disclosure describes and depicts ticket 155 including or indicating particular types of information, this disclosure recognizes that tickets 155 may include or reflect additional information about excavation projects. For example, tickets 155 may include or reflect information regarding the nature of the excavation work (e.g., burying a phone line, repairing a water pipe, etc.), whether explosives will be used, and the excavation type (e.g., inter alia, hand shoveling, using an auger, backhoe digging, or bulldozing). As another example, tickets 155 may further include or indicate driving directions to the work site and additional information or instructions regarding the work site, such as hazards on the work site or specific directions to locations within the work site. In some embodiments, ticket 155 includes or reflects data regarding the ticket itself, such as a ticket reference number (e.g., 000001 in the above exemplary ticket) or ticket generation date. This disclosure also recognizes that tickets 155 may be updated and stored in ticket database 140a after the ticket generation date. As an example, tickets 155 may be updated to include ticket status information, such as whether relevant utility operators have been notified and/or deployed, whether utility operators have marked the utilities and/or excavators have white lined the excavation site, and whether the ticket remains active or is otherwise closed or inactive.

Infrastructure disturbance reporting tool 130 may be configured to facilitate the purging. In particular embodiments, a purging engine of infrastructure disturbance reporting tool 130 is configured to facilitate the purging. As a nonlimiting example, purging engine may be configured to execute the following algorithm: (1) identify the current date; (2) calculate an expiration or inactive date by subtracting the duration threshold from the current date; (3) issuing a query to identify any tickets 155 with a ticket generation date on or before the calculated expiration/inactive date; (4) migrate the identified tickets 155 out of ticket database 140a.

In some embodiments, ticket database 140a is purged of tickets 155 deemed to be expired or inactive. Purging of database(s) 140 may involve (1) identifying tickets 155 stored in database 140 that meet or exceed a duration threshold; and (2) deleting, either temporarily or permanents, the identified tickets. Alternatively, purging of ticket database 140a may involve moving or migrating the identified tickets to a separate database rather than deletion.

The duration threshold used to identify expired or inactive tickets may be any suitable number. In certain embodiments, the duration threshold is 10 days. In other embodiments, the duration threshold is between 7-14 days. In yet other embodiments, the duration threshold is between 1-21 days.

Utility database 140b is configured to store, in any suitable form, information relating to infrastructure, such as underground utilities. In some embodiments, utility database 140b is configured to store positional information about a plurality of utilities within a particular geographical area (e.g., within a state, county, or other natural occurring boundary such as a river). Positional information may include information about the location of a utility (e.g., an address, a GPS coordinate, or a range of GPS coordinates), utility line characteristics (e.g., diameter, depth, pressurization etc.), utility type (e.g., water, gas, electrical), associated hazards (e.g., explosion, fire, toxicity, flooding), and contact information of relevant utility owners, land owners, or other interested parties. In certain embodiments, utility database 140b may also include a reference identifier assigned to each of the plurality of utilities.

In the embodiment illustrated in FIG. 1, system 100 includes excavators 150, which represent any person, object, or entity that may perform or be associated with any type of digging or excavation project. Excavators 150 may comprise a plurality of excavators 150, including excavator 150a, excavator 150b, and excavator 150c. Excavators 150 may communicate with an 811 center regarding anticipated excavations, e.g., via phone or computer, from which tickets 155 are generated and stored in databases 140. As will be known to a person of ordinary skill in the art, tickets 155 may reflect excavations planned to occur within a particular duration of time, e.g., 1 day-3 weeks after a corresponding ticket 155 is generated and/or stored.

As discussed above, system 100 may further include interested parties 165b and/or their associated devices, such as computers 165a and UAV 170. Responses 160 generated by infrastructure disturbance reporting tool 130 may be communicated or otherwise relayed to interested parties 165b and/or their associated devices 165a, 170. Interested parties 165b may be the same or different for any given utility owner, and in some cases the interested parties 165b identified to be contacted are selected based on their affiliation with a utility operator and/or their reported proximity to a particular utility. Interested parties 165b may also include persons or entities located in an area affected or otherwise impacted by a detected utility disturbance or responding to an area affected or otherwise impacted by a detected utility disturbance (e.g., emergency services such as firefighters, police, ambulance, 911 dispatch, etc.). The reported proximity may reflect real time or static information provided by, for, or on behalf of a utility owner. An exemplary algorithm for deciding which interested parties 165b a response 160 is generated for may comprise (1) identifying a utility location and a utility owner with associated interested parties 165b from utility database 140b; (2) identifying a computer 165a associated with a first interested party 165b within 50 miles of the utility location; (3) generating a response to a computer 165a of the first interested party 165b; (4) waiting 5 minutes for a response from the first interested party 165b; (5) identifying a computer 165a associated with a second interested party 165b within 150 miles of the utility location; (6) generating a response to a computer 165a of the second interested party 165b.

Responses 160 may be or comprise any suitable signal, operation, or action to aid in preventing, mitigating, or informing interested parties of potential damage to utilities. For example, response 160a is directed to computer 165a to alert interested party 165b of potential damage or safety hazards to or near their utility. Interested party 165b may comprise a utility owner, property owner, excavators 150, or any other person or entity who has an interest in the affected utility. In some embodiments, response 160a is an SMS text message, email, phone call, push notification and/or any other type of suitable form of electronic communication. Given the associated costs of damaging a utility, infrastructure disturbance reporting tool 130 may be configured to make determinations about generating response 160 as quickly as possible. In some embodiments, response 160 is generated within fifteen (15) minutes of receiving notification 125. In preferred embodiments, response 160 is generated within three (3) minutes of receiving notification 125. This disclosure recognizes a number of technical improvements that may shorten the duration of time between receiving notification 125 and generating response 160. For example, infrastructure disturbance reporting tool 130 may be configured to purge ticket database 140a as described herein, which may result in a more efficient (in both time and resources) query process. As another example, infrastructure disturbance reporting tool 130 may be configured to use a location indication or substitute value thereof (rather than a zone of interest), which may also result in a more efficient (in both time and resources) query process.

In certain embodiments, response 160 may engage or initiate a physical action. As an example, response 160b may cause or otherwise facilitate the deployment of UAV 170 to the detected disturbance location to assess the potential damage or hazard caused by the detected disturbance. As another example, response 160b may cause or otherwise facilitate actuation of a shut off valve to a utility determined to be affected by the detected disturbance. As yet another example, response 160b may cause or otherwise facilitate an interested party to physically inspect an affected utility. Although this disclosure depicts and describes particular types of responses, including physical actions (automated or manual), this disclosure contemplates that responses 160 may take any suitable form that facilitates the prevention or mitigation of damage resulting from disturbances to infrastructure.

Generally, excavator 150 submits (e.g., by call, online form, or any other form of communication) an excavation request resulting in the generation of ticket 155 comprising information about a particular excavation project. Ticket 155 may be transmitted over network 110 and stored in database 140a. Subsequently, infrastructure disturbance reporting tool 130 may receive notification 125 from external system 120 that indicates a detected disturbance at a particular location. Infrastructure disturbance reporting tool 130 may query database 140a to determine whether excavation is expected at, near or around the location of detected disturbance.

In some embodiments, infrastructure disturbance reporting tool 130 may query database 140a to determine, based on tickets 155, whether excavation is expected at, near or around the detected disturbance. Such query may define or otherwise indicate at least one date, enabling the filtration of tickets 155 to a particular time period (e.g., tickets 155 created and/or stored in database 140a within the past 14 days from the current date). One or more tickets 155 may be identified as a result of such query and infrastructure disturbance reporting tool 130 may analyze each to determine or otherwise predict whether the detected disturbance is expected and/or authorized or, alternatively, unexpected and/or unauthorized. As will be explained in further detail below, a detected disturbance may be determined to be unexpected and/or unauthorized if infrastructure disturbance reporting tool 130 is unable to identify a ticket corresponding to the detected disturbance.

In some embodiments, when the infrastructure disturbance reporting tool 130 determines or otherwise predicts that the detected disturbance is unexpected and/or unauthorized, infrastructure disturbance reporting tool 130 issues a query to database 140b to identify the scope of utilities potentially affected by the detected disturbance. Infrastructure disturbance reporting tool 130 may thereafter generate response(s) 160 to one or more interested parties 165b to confirm, prevent, and/or mitigate damage to utility infrastructure. In some embodiments, response(s) 160 are customized for interested parties 165b and may, e.g., be directed to a particular contact associated with interested parties 165 and/or facilitate a physical response.

FIG. 2 illustrates a method 200 for providing real-time responses to detected disturbances, according to certain embodiments. Some or all of the steps of method 200 may be performed by one or more modules of infrastructure disturbance reporting tool 130. The method 200 may include all or some of the steps illustrated in method 200 and, in certain embodiments, include one or more additional steps. For example, the steps of method 200 may be preceded by some other step (not described or illustrated) or, alternatively, be initiated as a later step.

As shown in FIG. 2., method 200 begins in a step 205 and continues to a step 210. At step 210, infrastructure disturbance reporting tool 130 receives a first notification (e.g., notification 125 of FIG. 1) indicating a detected utility disturbance and a location corresponding to the detected utility disturbance. As an example, the received notification may indicate a utility disturbance occurring at or near 32° 59′ 47.526″ N, 96° 41′ 51.2016″ W. In some embodiments, the notification is received from an external system (e.g., external system 120 of FIG. 1) configured to detect and/or identify infrastructure disturbances, such as a fiber optic sensing system. The notification may be sent over network 110 and may be received by a network interface of infrastructure disturbance reporting tool 130 (e.g., interface 440 of FIG. 4). An example of an algorithm that may be implemented by a network interface comprises: (1) receive, from external system 120, a notification comprising an indication of a detected utility disturbance and a location corresponding to the detected utility disturbance; and (2) send the received notification (or some or all of the contents thereof) to an assessment engine of infrastructure disturbance reporting tool 130.

In certain embodiments, infrastructure disturbance reporting tool 130 may store, in memory (e.g., memory 420 of FIG. 4), the received notification and/or any information included in notification 125. In some embodiments, after receiving the notification at step 210, the method 200 continues to a step 220.

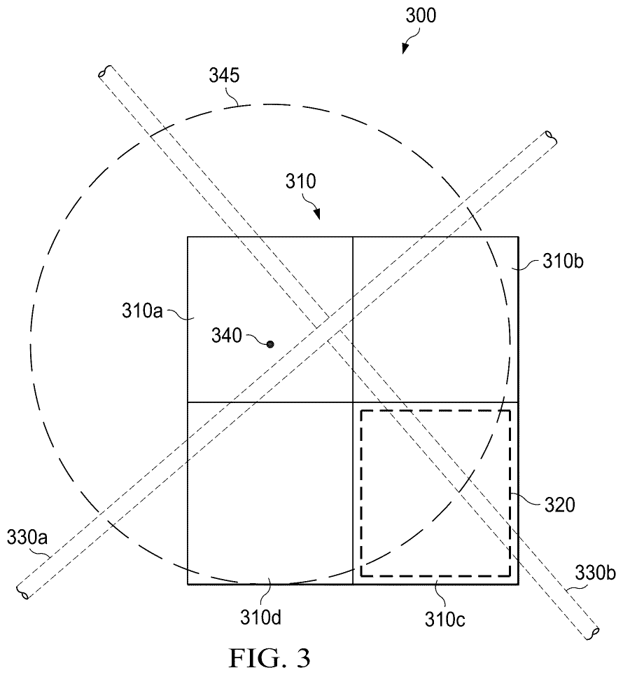

At step 220, infrastructure disturbance reporting tool 130 (or a module thereof, e.g., assessment engine) identifies an area of interest based on the notification received at step 210. In certain cases, the area of interest may represent a geographical area (1) including the utilities at risk of being damaged by the detected disturbance identified in the received notification 125; and/or (2) that may be impacted by healthy and safety concerns resulting from damage caused by the detected disturbance. An example of an area of interest is identified and described in reference to FIG. 3. In some embodiments, infrastructure disturbance reporting tool 130 identifies an area of interest based on information provided with the first notification, such as the location indication corresponding to the detected infrastructure disturbance. The area of interest may be determined in any suitable manner. An example of an algorithm that may be implemented by infrastructure disturbance reporting tool 130 (or a module thereof, e.g., assessment engine) at step 220 comprises: (1) analyze the received notification to identify an indication of a location associated with the detected disturbance; (2) confirm the location indication is a pinpoint location (e.g., geographic coordinates) or otherwise translate the location indication to a pinpoint location; (3) establish an area of interest by determining and applying a radius (e.g., 50 feet, 100 feet, 1000 feet, 5 miles, 40 miles) around the pinpoint location. Although this disclosure describes and illustrates determining an area of interest in a particular way, this disclosure recognizes that an area of interest may be determined via any suitable method, utilizing any suitable data (e.g., forming boundaries based on geographic features) for determining an area of interest. This disclosure also recognizes that the same radius need not be applied when determining an area of interest. A radius of 50 feet may be used, e.g., when hand tool digging is detected and a radius of 1 mile may be used, e.g., when mechanical excavation is detected.

In certain embodiments, infrastructure disturbance reporting tool 130 may store, in memory (e.g., memory 420 of FIG. 4), the area of interest identified at step 220. In some embodiments, after identifying the area of interest, the method 200 continues to a step 230.

At step 230, infrastructure disturbance reporting tool 130 issues a first database query to identify at least one ticket 155 of interest based on information included or indicated in the notification received at step 210. In some embodiments, the ticket of interest is identified based at least on a location indicated in the received notification and a date associated with the received notification (e.g., date that the notification was received). As an example, infrastructure disturbance reporting tool 130 may issue a search query specifying 32° 59′ 47.526″ N, 96° 41′ 51.2016″ W and a notification date of Apr. 1, 2025. This disclosure recognizes that the first database query may include a location indicated in the received notification 125, a substitute value thereof, and/or a zone of interest that includes the location indicated in the received notification 125. As discussed above, the first database query may be directed to a database that infrastructure disturbance reporting tool 130 includes and/or is otherwise communicatively coupled to.

An example of an algorithm that may be implemented by infrastructure disturbance reporting tool 130 (or a module thereof, e.g., assessment engine) at step 230 comprises: (1) analyze the first notification to identify an indication of a location associated with the detected disturbance; (2) confirm whether the location indication is formatted appropriately for the database query; (3) if the location indication is formatted appropriately for the database query, generate a database query that includes the location indication; (4) if the location indication is not formatted appropriately for the database query, (a) determine at least one substitute value for the location indication, where the substitute value defines the location differently than the location indication in the received notification (e.g., redefining latitude/longitude coordinates as a street address); and (b) generate a database query that includes the substitute value; (5) identifying an earliest ticket date associated with the received notification by subtracting a staleness threshold (e.g., 14 days) from the date associated with the received notification (e.g., Apr. 1, 2025); (6) adding, to the database query, the determined earliest ticket date; and (7) communicating the database query to one or more databases 140 (e.g., database 140a of FIG. 1) to facilitate the identification of one or more tickets that concern anticipated excavation at or near the location indicated in the notification received at step 210, which were generated and/or submitted before the determined earliest ticket date (e.g., Mar. 18, 2025).

In certain embodiments, infrastructure disturbance reporting tool 130 (or a module thereof, e.g., assessment engine) at step 230 performs one or more of the following steps: (1) analyze the first notification to identify an indication of a location associated with the detected disturbance, where the indication identifies raw latitude and longitude coordinates; (2) convert the latitude and longitude coordinates to geographic point(s) using Spatial Reference Identifier 4326; (3) create a circular buffer around the detected disturbance location in meters; and (4) convert the circular buffer from geography type coordinates to geometry type coordinates using, e.g., well-known text (WKT).

At step 240, infrastructure disturbance reporting tool 130 issues a second database query to identify at least one utility within the area of interest determined at step 220. In some embodiments, infrastructure disturbance reporting tool 130 may determine the at least one utilities within the area of interest by overlaying the area of interest on one or more utility maps (physical or digital) that identify the location of at least one utility. An example of an algorithm that may be implemented by infrastructure disturbance reporting tool 130 (or a module thereof, e.g., assessment engine) at step 240 comprises: (1) identify one or more utility maps that include or otherwise represent the location indication from the notification received at step 210; (2) overlay a representation of the area of interest identified at step 220 on each of the identified utility maps based on the location indication; and (3) identify all utilities located within the overlay (or within the boundaries of the overlay).

In certain embodiments, infrastructure disturbance reporting tool 130 (or a module thereof, e.g., assessment engine) at step 240 performs one or more of the following steps: (1) analyze the first notification to identify an indication of a location associated with the detected disturbance, where the indication identifies raw latitude and longitude coordinates; (2) convert the latitude and longitude coordinates to a metric point; (3) create a metric space around the metric point to serve as a buffer around the detected disturbance location; and (4) convert the buffer from a metric space to an SRID 4326 format.

Results of the query issued at step 240 may indicate the presence of at least one utility within the area of interest identified at step 220. As an example, FIG. 2 illustrates that two utilities—a gas line and a water line—are included within the area of interest 345. In certain embodiments, results of the query issued at step 240 indicate information regarding each of the identified utilities, such as positional information, associated hazards (e.g., electrical shock, explosion.), and status information (e.g., active, inactive, under construction, etc.). It is also possible that the query issued at step 240 fails to identify any utilities located within the area of interest. In such cases, the method 200 may proceed to an end step 285.

In some embodiments, any results, information, or determinations from the query issued at step 240 may be stored in memory 134 of infrastructure disturbance reporting tool 130 for use in other steps of method 200. In some embodiments, such as the embodiment illustrated in FIG. 2, the method 200 proceeds to a decision step 250 after issuing a second database query at step 230.

At step 250, infrastructure disturbance reporting tool 130 determines whether at least one of the tickets 155 of interest (identified at step 230) corresponds to the notification received at step 210. By determining whether the received notification corresponds to a particular ticket 155 of interest, infrastructure disturbance reporting tool 130 may determine or otherwise predict whether the detected disturbance is unexpected and/or unauthorized. Infrastructure disturbance reporting tool 130 may be configured to make this determination by analyzing one or more fields of each identified ticket 155 of interest. As an example, infrastructure disturbance reporting tool 130 may compare data indicated in the excavation location field of tickets 155 of interest to the location indication in the notification received at step 210. In some embodiments, infrastructure disturbance reporting tool 130 may reformat the data indicated in the excavation location field of tickets 155 of interest and/or the location indication in the notification in order to perform the comparison. Infrastructure disturbance reporting tool 130 may further be configured to determine a confidence that each identified ticket 155 of interest corresponds to the received notification. As an example, infrastructure disturbance reporting tool 130 may assess a 0.90 confidence that a first ticket 155 of interest corresponds to the notification received at step 210 and a 0.3 confidence that a second ticket 155 of interest corresponds to the notification received at step 210 based on a comparison of information identified in tickets 155 of interest and/or the received notification. In some embodiments, infrastructure disturbance reporting tool 130 is configured to select, as the corresponding ticket 155 of interest, the ticket 155 of interest associated with the highest confidence score. In embodiments that utilize confidence scores as a means of assessment, infrastructure disturbance reporting tool 130 may also use a confidence threshold (e.g., 0.95) when determining whether a ticket 155 of interest corresponds to the notification. Taking the example above, infrastructure disturbance reporting tool 130 may determine that neither the first or second tickets 155 of interest correspond to the notification received at step 210 because their respective confidence scores do not meet or exceed the confidence threshold.

An example of an algorithm that may be implemented by infrastructure disturbance reporting tool 130 (or a module thereof, e.g., assessment engine) at step 250 comprises (1) identifying a location of a detected infrastructure disturbance from a notification (e.g., notification received at step 210); (2) creating a buffer around the location of a detected infrastructure disturbance; (3) for each ticket of interest (e.g., ticket of interest identified at step 230), generate a predicted excavation area based on data provided in each ticket about the anticipated excavation (e.g., data provided in “Notes” section of Ticket 000001 above, indicating that the anticipated excavation area will extend from the north property line to 10 feet from the south property line and from the east property line to 20 feet west); (4) compare each predicted excavation area corresponding to a particular ticket of interest to at least one of the detected infrastructure disturbance location or the buffer around the detected infrastructure disturbance location; (5) based on the comparisons, determine which of the predicted excavation areas most closely overlaps or matches the at least one of the detected infrastructure disturbance location or the buffer around the detected infrastructure disturbance location, where a confidence score may be used to determine the overlap and/or match; and (6) identify the ticket whose predicted excavation area most closely overlaps or matches the at least one of the detected infrastructure disturbance location or the buffer around the detected infrastructure disturbance location as corresponding to the detected infrastructure disturbance.

Decision step 250 results in one of two determinations: (1) a ticket 155 of interest is determined to correspond to the received notification; or (2) no ticket 155 of interest is determined to correspond to the received notification. As shown in FIG. 2, if a ticket 155 of interest is determined to correspond to the first notification, method 200 may proceed to a decision step 260. This determination may indicate that excavation was anticipated at the detected location because, e.g., excavator 150a contacted a local 811 center prior to beginning his excavation project. Alternatively, as is also shown in FIG. 2, if no ticket 155 of interest is determined to correspond to the first notification, method 200 may proceed to a step 270. This determination may indicate that excavation was not anticipated at the detected location because, e.g., excavator 150a failed to contact a local 811 center prior to beginning his excavation project. In certain embodiments, any results, information, or determinations from decision step 250 may be stored in memory 134 of infrastructure disturbance reporting tool 130 for use in other steps of method 200.

At decision step 260, infrastructure disturbance reporting tool 130 determines whether the corresponding ticket 155 of interest (identified at step 250) indicates the type of infrastructure disturbance detected or otherwise determined by external system 120. As discussed above, notifications 125 from external system 120 may provide such information. In some embodiments, determining whether the corresponding ticket 155 of interest indicates the detected disturbance type involves comparing one or more fields of tickets 155 to information in the notification received at step 210. As an example, infrastructure disturbance reporting tool 130 may compare data indicated in a ticket field indicating the anticipated work type/excavation equipment to the disturbance classification identified in the notification received at step 210. Such information may be used by infrastructure disturbance reporting tool 130 (alone or in combination with other information identified in tickets 155 of interest and/or the received notification) to assess a confidence that the corresponding ticket 155 of interest indicates the detected disturbance type. For example, infrastructure disturbance reporting tool 130 may assess a 0.80 confidence that a third ticket 155 indicates a detected disturbance type when the third ticket 155 identifies “heavy equipment” in the anticipated work type/excavation equipment field and the detected disturbance type indicates excavation by excavator. As another example, infrastructure disturbance reporting tool 130 may assess a 0.05 confidence that a fourth ticket 155 indicates a detected disturbance type when the fourth ticket 155 identifies “shovel” in the anticipated work type/excavation equipment field and the detected disturbance type indicates excavation by excavator. As described above with respect to decision step 250, assessing confidence may include a confidence threshold. Such threshold may be the same or different than the confidence threshold used to determine whether tickets 155 of interest correspond to the received notification.

An example of an algorithm that may be implemented by infrastructure disturbance reporting tool 130 (or a module thereof, e.g., assessment engine) at step 260 comprises (1) retrieving a disturbance type indicated by a first notification from a memory; (2) retrieving a disturbance type indicated by a ticket of interest; (3) comparing the disturbance type indicated by the first notification to the disturbance type indicated by the ticket of interest; and (4) determine whether the disturbance type indicated by the first notification matches or otherwise corresponds to the disturbance type indicated by the ticket of interest based on the comparison. In some embodiments, infrastructure disturbance reporting tool 130 may be configured to appreciate differences in terminology to determine whether a detected disturbance type matches or corresponds to a disturbance type indicated in a ticket of interest. In such cases, infrastructure disturbance reporting tool 130 may be configured to query a database (e.g., database 140) for a listing of acceptable terms that may be encompassed by a disturbance type indicated in a notification. As an example, to determine whether a first ticket corresponds to a first notification, infrastructure disturbance reporting tool 130 may determine that the first notification indicates a “manual” excavation and query database 140 for a listing of acceptable terminology for “manual” excavations that includes, e.g., “shovel,” “hand tools.” Infrastructure disturbance reporting tool 130 may then assess whether the first ticket includes an indication that excavation be “manual” or performed via “shovel” or “hand tools” (or permutations thereof) when determining whether detected disturbance type matches or corresponds to the first ticket. A similar listing of acceptable terminology may also be stored for other types of detected disturbances, such as “mechanical” excavations that might otherwise be indicated on tickets as anticipated excavations using, e.g., “heavy equipment” or “excavator.”

Decision step 260 results in one of two determinations: (1) corresponding ticket 155 of interest is determined to indicate the detected disturbance type of the received notification; or (2) corresponding ticket 155 of interest is determined not to indicate the detected disturbance type of the received notification. As shown in FIG. 2, if corresponding ticket 155 of interest is determined to indicate the detected disturbance type, method 200 may proceed to end step 285. This determination may indicate that this type of excavation is anticipated at the detected location because, e.g., excavator 150a contacted a local 811 center prior to beginning his excavation project and reported this type of excavation. Under these conditions, infrastructure disturbance reporting tool 130 may predict that the risk of damaging surrounding utilities is low and determine that a response 160 is unnecessary. This risk prediction may change, however, upon a further determination by infrastructure disturbance reporting tool 130 that excavation is not proceeding with the benefit of having utility infrastructures marked (e.g., by flagging, or color coding utility infrastructures), which may be informed by the status field of the corresponding ticket 155 of interest. In such case, the method 200 may instead proceed to a step 270.

As is also illustrated in FIG. 2, if corresponding ticket 155 of interest is determined not to indicate the detected disturbance type of the received notification, the method 200 may proceed to a step 270. This determination may indicate that this type of excavation is not anticipated at the detected location because, e.g., excavator 150a contacted a local 811 center prior to beginning his excavation project and reported a different type of excavation. Under these conditions, infrastructure disturbance reporting tool 130 may predict that the risk of damaging surrounding utilities is high and determine that a response 160 should be generated. In some embodiments, any results, information, or determinations from decision step 260 may be stored in memory 134 of infrastructure disturbance reporting tool 130 for use in other steps of method 200.

Upon determining that corresponding ticket 155 of interest fails to indicate the detected disturbance type of the received notification, the method 200 may proceed to a step 270 where infrastructure disturbance reporting tool 130 identifies a contact for each utility identified as being within the area of interest (as a result of step 240). Such contact information may be stored in one or more databases 140 and, in some embodiments, is stored in utility database 140b. Infrastructure disturbance reporting tool 130 (or a module thereof) may be configured to query such database(s) 140 using, e.g., a reference identifier associated with each utility within the area of interest, to determine an appropriate contact for each of the identified utilities. One or more utilities may be associated with the same contact. For example, infrastructure disturbance reporting tool 130 may identify Sam Jones as the appropriate contact for a first utility, a second utility, and a third utility, all of which are owned by Operator A. But even utilities owned by the same operator may be associated with different contacts. For example, infrastructure disturbance reporting tool 130 may identify Sam Jones as the appropriate contact for the first utility, John Doe as the appropriate contact for the second utility, and Jane Doe as the appropriate contact for the third utility. Different contacts may be preferable if, e.g., the contacts are responsible for managing utilities in different regions. In addition to the contact name, database 140 may include other relevant contact information corresponding to a particular utility.

Exemplary database entries are provided below, which identify relevant contacts for five utilities identified within an area of interest:

| Reference | | Primary | Preferred Method |
|---|---|---|---|
| No. | Operator | Contact | of Contact |
| 11223344 | Operator A | Sam Jones | sj@operatora.com |
| 11223345 | Operator A | John Doe | (444) 123-4567 |
| 11223346 | Operator A | Jane Doe | ja@operatora.com |
| 22334455 | Operator B | Bob Williams | (222) 747-1477 |
| 33445566 | Operator C | Megan Smith | msmith@opc.com |

Each entry may include some or all of the fields above and alternatively may include one or more other fields that correspond to a particular utility. As an example, database 140 may additionally include includes response protocols or instructions associated with each utility. A response protocol or instruction may indicate, e.g., the required conditions for issuing a response 160 associated with the respective utility (e.g., issue response 160 as an email and/or text message to preferred method of contact if current time is between 8 am-6 pm; issue response 160 as a push notification to preferred method of contact if current time is between 6:01 pm-7:59 am) or actions that infrastructure disturbance reporting tool 130 should facilitate, such as deployment of a UAV or closing a utility valve.

An example of an algorithm that may be implemented by infrastructure disturbance reporting tool 130 (or a module thereof, e.g., assessment engine) at step 270 comprises (1) creating a buffer around a detected infrastructure disturbance location received from a notification (e.g., a notification received at step 210); (2) using the buffer to retrieve from a memory (e.g., database 140, memory 134, memory 420) a plurality of utility operators who have utility infrastructures located within the buffer; (2) retrieving from a memory (e.g., database 140, memory 134, memory 420) a plurality of contacts associated with each utility operator; and (3) determine a preferred contact for each utility operator based on either: (a) utility operator preferences stored in a memory, (b) determining the contact with the nearest proximity to the detected infrastructure disturbance location, or (c) retrieving the availability of each contact and determining which contact is most available.

After identifying a relevant contact for each identified utility at step 270, method 200 may proceed to a step 280. At step 280, infrastructure disturbance reporting tool 130 generates a response 160 to each identified contact. In some embodiments, infrastructure disturbance reporting tool 130 sends (or facilitates the sending of) response 160 over network 110 to device 165a to notify interested parties 165b about the detected excavation that may cause damage to a utility and/or result in a health and safety risk. Response 160 may also be directed to a device (e.g., UAV 170) configured to perform an action that confirms, prevents, or mitigates damage to utilities or health and safety concerns. As an example, infrastructure disturbance reporting tool 130 may be configured to facilitate the shutting off or disabling of affected utilities.

In some embodiments, step 280 may comprise generating a response in accordance with any response protocols or instructions corresponding to the identified utility. As an example, database 140 may indicate that a fourth utility identified within the area of interest, having Reference No. 22334455, is associated with a response protocol requiring (1) that the primary contact (Bob Williams) be contacted via phone call and text message upon a determination by infrastructure disturbance reporting tool 130 that detected excavation is unanticipated or unauthorized or, alternatively, presents a health and safety risk; and (2) deployment of a UAV to the location indicated in the received notification to confirm and/or mitigate damage to utilities. Accordingly, infrastructure disturbance reporting tool 130 may generate two responses 160 directed to device 165a associated with Bob Williams and one response 160 directed to UAV 170 providing details about the detected disturbance.

Response 160 may indicate one or more of an indication of the location of the detected disturbance (e.g., coordinates, a nearby street address, a map or link to a map), a time of detected disturbance, a type of detected disturbance, and hazard(s) associated with the disturbance. In some embodiments, infrastructure disturbance reporting tool 130 is configured to perform utility damage risk assessments and/or provide recommended follow-up actions. In such embodiments, response 160 may further include a utility damage risk assessment indicator (e.g., high, medium, low) and/or a recommended action. In certain embodiments, response 160 includes a follow-up mechanism (e.g., a link to a website) that permits the recipient to provide follow-up commentary (e.g., observations or mitigation actions) regarding the detected disturbance and/or an affected utility.

In some embodiments, any results, information, or determinations from step 270 may be stored in memory 134 of infrastructure disturbance reporting tool 130 for use in other steps of method 200. As illustrated in FIG. 2, after generating a response to each identified contact at step 280, the method 200 may proceed to end step 285.

As described above, steps of method 200 may be performed iteratively or in any order and may comprise more or less steps than illustrated in FIG. 2.

This disclosure specifically recognizes that, in some instances, it may be preferable to include a zone of interest in the search query issued at step 230 rather than a location indication or substitute value. For example, if external system 120 is unable to reliably provides accurate location information for detected disturbances, infrastructure disturbance reporting tool 130 may include in its query a zone of interest, which may or may not be the same as the area of interest identified in step 210. The zone of interest may provide a detected location buffer (e.g., +/−5 miles from the location indication), allowing infrastructure disturbance reporting tool 130 to identify active tickets 155 that correspond to planned excavation activities in the zone of interest. Infrastructure disturbance reporting tool 130 may issue subsequent queries to one or more databases 140 that may further narrow the scope of potential tickets 155 of interest.

This disclosure also recognizes that determining whether at least one of the tickets 155 of interest corresponds to the notification received at step 210 may include a further comparison of other fields of tickets 155. As an example, infrastructure disturbance reporting tool 130 may compare an excavation depth value in each ticket 155 of interest to a detected disturbance depth indicated in notification 125 when predicting whether the detected excavation was authorized. Similar information may also be used by infrastructure disturbance reporting tool 130 to perform a utility damage risk assessment. For example, infrastructure disturbance reporting tool 130 may consider excavation depth values in tickets 155 in combination with either a detected disturbance depth indicated in notification 125 or utility depth information provided in utility database 140b when performing a utility damage risk assessment. In such embodiments, infrastructure disturbance reporting tool 130 may determine that the risk of utility damage is “low” when, e.g., the detected disturbance depth is ≥30 feet above a potentially affected utility. Infrastructure disturbance reporting tool 130 may further determine that the risk of utility damage is “medium” and “high” when, e.g., the detected disturbance depth is 20 feet or 10 feet, respectively, above a potentially affected utility.

Although this disclosure describes assessing utility damage risk based on specific values, this disclosure recognizes that utility damage risk may be assessed using any suitable values, such as distance from the detected disturbance location to a potentially affected utility. As an example, infrastructure disturbance reporting tool 130 may be configured to determine that the risk of utility damage is “low,” “medium” and “high” when, e.g., the detected disturbance location is ≥50 feet, 30 feet, or 20 feet, respectively, from a potentially affected utility. Infrastructure disturbance reporting tool 130 may be configured to perform a utility damage risk assessment that considers the variability of one or more values stored in database(s) 140 and/or in notifications 125. For example, infrastructure disturbance reporting tool 130 may calculate a utility damage risk score that assesses depth and distance values alone or in combination with others.

In some embodiments, infrastructure disturbance reporting tool 130 may be configured to determine that the risk of utility damage is “low” when the detected disturbance type is a hand tool and “high” when the detected disturbance type is heavy machinery, such as an excavator. This determined risk may also affect a utility damage risk score assessed by infrastructure disturbance reporting tool 130. In some embodiments, infrastructure disturbance reporting tool 130 calculates a numerical utility damage risk score between 0 (indicating no risk) and 10 (indicating maximum risk). The numerical score or a translation thereof may be communicated in a response 160. A translation of the numerical score may, in some cases, be represented by risk levels, where, e.g., an estimated score of 0-3.5 indicates “low” risk, an estimated score of 3.6-7 indicates “medium” risk, and an estimated score of 7.1-10 indicates “high” risk. As a person of skill in the art will recognize, these are exemplary values and can be any suitable number. In some embodiments, preferences regarding risk tolerance for a particular utility are included in a response protocol or instruction stored in database(s) 140.

This disclosure specifically contemplates that infrastructure disturbance reporting tool 130 may be configured to generate response 160 if it determines that the risk of utility damage or the risk of community health and safety is “high,” despite a determination that the detected excavation is anticipated or authorized. For example, infrastructure disturbance reporting tool 130 may be configured to generate a response 160 to interested party 165b in the event a detected disturbance presents a health and safety risk, such as a gas leak or fire. In certain embodiments, infrastructure disturbance reporting tool 130 is may generate a response 160 that facilitates widespread awareness of the health and safety risk, such as a community emergency system (e.g., loudspeaker, siren). As another example, infrastructure disturbance reporting tool 130 may be configured to generate a response 160 in the event the notification includes suitable information for determining that actual damage has occurred to a utility. As yet another example, infrastructure disturbance reporting tool 130 may determine that risk of community health and safety is “high” in view of one or more utility line characteristics, such as the pressurization of a utility line. For example, infrastructure disturbance reporting tool 130 may generate a response 160 despite a determination that the detected excavation is anticipated or authorized if it determines that a detected disturbance is near (e.g., within a distance threshold, such as 30 feet) a utility line that is highly pressurized (e.g., meets or exceeds a pressure threshold, such as 100 psi). Such a response may provide an early warning for interested persons regarding potential damage to high-risk lines. In some embodiments, infrastructure disturbance reporting tool 130 determines a risk to be “low” when the pressure of the utility line is under 10 psi, “medium when the pressure of the utility line is above 10 psi and under 100 psi, and “high” when the pressure of the utility line is over 100 psi.

This disclosure also contemplates that infrastructure disturbance reporting tool 130 may be configured to detect and respond to discrepancies found within a ticket 155 stored in ticket database 140a. For example, as discussed above in reference to step 260, infrastructure disturbance reporting tool 130 may be configured to generate response 160 when the detected excavation activity does not correspond to excavation activity identified in a ticket of interest (or ticket determined to correspond to notification 125). Infrastructure disturbance reporting tool 130 may further determine if the person or entity associated with a ticket 155 stored in ticket database 140a is actually the person or entity that will be performing excavation services (e.g., determining if the person or entity performing the excavation is a sub-contractor). For example, infrastructure disturbance reporting tool 130 may generate a response 160 to either fly a UAV 170 over the excavation site or send operator 165b to the excavation site to inspect the excavation operations.

FIG. 3 illustrates an exemplary map 300 identifying utility infrastructure 330 located within an area of interest 345, as identified by infrastructure disturbance reporting tool 130 of FIG. 1. Map 300 depicts a representation of utility infrastructure 330 relative to land 310, which has been divided into four parcels 310a-d. As will be understood by a person of ordinary skill in the art, land 310 may be divided into any number of parcels and shapes as necessary and/or desired.

Utility infrastructure 330 may represent any suitable infrastructure for utilities, including underground pipes or lines. In some embodiments, utility infrastructure 330 may be used to transport hazardous or potentially hazardous materials, such as compressed natural gas, sewage, hydrocarbons, high voltage electricity, etc. Utility infrastructure 330 may be located above or below ground level and may be positioned through or across land 310. Infrastructure for two utilities are depicted in FIG. 3: a first utility line 330a and a second utility line 330b. In some embodiments, utility line 330a is a water line and utility line 330b is a gas line. In other embodiments, utility line 330a is an electrical line and utility line 330b is a sewage line.

As discussed above in reference to FIGS. 1 and 2, utility database 140b may include positional information about the utility infrastructure 330. Such information may include, e.g., representations or indications of the location of utility infrastructure 330, depth of utility infrastructure, designations of utility type (e.g., water, gas, electric, sewage), and reference identifiers for each utility line. In some embodiments, utility database 140b also stores information about land 310 associated with utility infrastructure 330, such as identifiers of land parcels 310a-d and/or their respective owners.

As illustrated in FIG. 3, a disturbance to utility infrastructure 330 is detected on parcel 310a at disturbance location 340. In some cases, disturbance location 340 represents a position or location on map 300 where excavation activities (e.g., digging; movement of heavy machinery) have been detected by external system 120. In other cases, disturbance location 340 represents a position or a location on map 300 where non-excavation activities have been detected by external system 120 (e.g., excavator 150 may have physically bumped into an above ground utility; unknown person/animal walking near a utility). In either case, such disturbance is detected by external system 120, which in turn generates notification 125 indicating, inter alia, disturbance location 340. Upon receiving such notification 125 from external system 120, infrastructure disturbance reporting tool 130 may determine whether to generate a response 160. In some embodiments, infrastructure disturbance reporting tool 130 executes the method 200 to do so.

In some embodiments, infrastructure disturbance reporting tool 130 issues one or more queries to database(s) 140 to determine whether to generate a response 160. As an example, infrastructure disturbance reporting tool 130 may issue a query to ticket database 140a to determine whether the detected disturbance at disturbance location 340 is anticipated and/or authorized. To do so, infrastructure disturbance reporting tool 130 may submit a query to ticket database 140a, which includes one or more of an indication of location disturbance 340 (e.g., as included in notification 125), a substitute value representing location disturbance 340, or a zone of interest that includes location disturbance 340, to identify potential excavation tickets 155 that correspond to the detected disturbance (also referred to herein as tickets of interest). In some embodiments, such query returns ticket of interest 320 reflecting an anticipated excavation site on parcel 310c. The anticipated excavation site may include all or some of parcel 310c (or even other parcels, such as parcels 310a, 310b, and 310d), and ticket of interest 320 may provide such details.

As described above in reference to FIG. 2, infrastructure disturbance reporting tool 130 may be configured to determine area of interest 245, which represents a geographical region that may include utility infrastructure 230 affected by a detected disturbance (e.g., the disturbance detected by external system 120 at disturbance location 240). Area of interest 345 may be any desired shape or size to adequately search for utility infrastructure 330 within a suitable proximity of disturbance location 340. In some embodiments, area of interest 345 may take the shape of the land parcel 310 on which disturbance location 340 was located. In some embodiments, area of interest 345 may be formed by creating a radius around disturbance location 340 ranging from 0 to 1000 feet. In some embodiments, area of interest 345 may be created (or generated or otherwise formed) by infrastructure disturbance reporting tool 130 of FIG. 1.

As depicted in FIG. 3, first utility line 330a and second utility line 330b are positioned within area of interest 345. Infrastructure disturbance reporting tool 130 may determine whether first utility line 330a and second utility line 330b are at risk for damage or may cause a health and safety concern by determining or otherwise predicting whether the detected disturbance was anticipated or authorized. Taking the example illustrated here, infrastructure disturbance reporting tool 130 may determine that the disturbance detected at disturbance location 340 does or does not correspond to ticket of interest 320. As described above, infrastructure disturbance reporting tool 130 may make such determination based on some or all of the information provided in notification 125, ticket of interest 345, and information about first utility line 330a and second utility line 330b stored in utility database 140b.

FIG. 4 is a block diagram illustrating computer system 400 configured to implement the method of FIG. 2, according to some embodiments. As described above, infrastructure disturbance reporting tool 130 may be a program that is implemented by a processor of a computer system such as computer system 400. Computer system 400 may be any suitable computing system in any suitable physical form. In some embodiments, computer system 400 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, a mainframe, a mesh of computer systems, a server, an application server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. In some embodiments, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

One or more computer systems 400 may perform one or more steps of one or more methods described or illustrated herein. In some embodiments, one or more computer systems 400 provide functionality described or illustrated herein. In some embodiments, software running on one or more computer systems 400 performs one or more steps of one or more methods described or illustrated herein or provides functionality described or illustrated herein. Some embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. In some embodiments, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. In some embodiments, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

Computer system 400 may include a processor 410, memory 420, storage 430, an input/output (I/O) interface 440, a communication interface 450, and a bus 460 in some embodiments, such as depicted in FIG. 4. Although this disclosure describes and illustrates a particular computer system having a particular number of particular components in a particular arrangement, this disclosure contemplates any suitable computer system having any suitable number of any suitable components in any suitable arrangement.

Processor 410 includes hardware for executing instructions, such as those making up a computer program, in some embodiments. For example, processor 410 may execute phone dialer selection tool 150 in some embodiments. In some embodiments, to execute instructions, processor 410 may retrieve (or fetch) the instructions from an internal register, an internal cache, memory 420, or storage 430; decode and execute them; and then write one or more results to an internal register, an internal cache, memory 420, or storage 430. In some embodiments, processor 410 may include one or more internal caches for data, instructions, or addresses. This disclosure contemplates processor 410 including any suitable number of any suitable internal caches, where appropriate. In some embodiments, processor 410 may include one or more instruction caches, one or more data caches, and one or more translation lookaside buffers (TLBs). Instructions in the instruction caches may be copies of instructions in memory 420 or storage 430, and the instruction caches may speed up retrieval of those instructions by processor 410. Data in the data caches may be copies of data in memory 420 or storage 430 for instructions executing at processor 410 to operate on; the results of previous instructions executed at processor 410 for access by subsequent instructions executing at processor 410 or for writing to memory 420 or storage 430; or other suitable data. The data caches may speed up read or write operations by processor 410. The TLBs may speed up virtual-address translation for processor 410. In some embodiments, processor 410 may include one or more internal registers for data, instructions, or addresses. This disclosure contemplates processor 410 including any suitable number of any suitable internal registers, where appropriate. Where appropriate, processor 410 may include one or more arithmetic logic units (ALUs); be a multi-core processor; or include one or more processors 175. Although this disclosure describes and illustrates a particular processor, this disclosure contemplates any suitable processor.

Memory 420 may include main memory for storing instructions for processor 410 to execute or data for processor 410 to operate on. In some embodiments, computer system 400 may load instructions from storage 430 or another source (such as, for example, another computer system 400) to memory 420. Processor 410 may then load the instructions from memory 420 to an internal register or internal cache. To execute the instructions, processor 410 may retrieve the instructions from the internal register or internal cache and decode them. During or after execution of the instructions, processor 410 may write one or more results (which may be intermediate or final results) to the internal register or internal cache. Processor 410 may then write one or more of those results to memory 420. In some embodiments, processor 410 executes only instructions in one or more internal registers or internal caches or in memory 420 (as opposed to storage 430 or elsewhere) and operates only on data in one or more internal registers or internal caches or in memory 420 (as opposed to storage 430 or elsewhere). One or more memory buses (which may each include an address bus and a data bus) may couple processor 410 to memory 420. Bus 460 may include one or more memory buses, as described below. In some embodiments, one or more memory management units (MMUs) reside between processor 410 and memory 420 and facilitate accesses to memory 420 requested by processor 410. In some embodiments, memory 420 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 420 may include one or more memories 180, where appropriate. Although this disclosure describes and illustrates particular memory, this disclosure contemplates any suitable memory.

Storage 430 may include mass storage for data or instructions. In some embodiments, storage 430 may include a hard disk drive (HDD), a floppy disk drive, flash memory, an optical disc, a magneto-optical disc, magnetic tape, or a Universal Serial Bus (USB) drive or a combination of two or more of these. Storage 430 may include removable or non-removable (or fixed) media, where appropriate. Storage 430 may be internal or external to computer system 400, where appropriate. In some embodiments, storage 430 is non-volatile, solid-state memory. In some embodiments, storage 430 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 430 taking any suitable physical form. Storage 430 may include one or more storage control units facilitating communication between processor 410 and storage 430, where appropriate. Where appropriate, storage 430 may include one or more storages 140. Although this disclosure describes and illustrates particular storage, this disclosure contemplates any suitable storage.

I/O interface 440 may include hardware, software, or both, providing one or more interfaces for communication between computer system 400 and one or more I/O devices. Computer system 400 may include one or more of these I/O devices, where appropriate. One or more of these I/O devices may enable communication between a person and computer system 400. In some embodiments, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 185 for them. Where appropriate, I/O interface 440 may include one or more device or software drivers enabling processor 410 to drive one or more of these I/O devices. I/O interface 440 may include one or more I/O interfaces 185, where appropriate. Although this disclosure describes and illustrates a particular I/O interface, this disclosure contemplates any suitable I/O interface.

Communication interface 450 may include hardware, software, or both providing one or more interfaces for communication (such as, for example, packet-based communication) between computer system 400 and one or more other computer systems 400 or one or more networks (e.g., network 110). In some embodiments, communication interface 450 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 450 for it. In some embodiments, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 450 for any of these networks, where appropriate. Communication interface 450 may include one or more communication interfaces 190, where appropriate. Although this disclosure describes and illustrates a particular communication interface, this disclosure contemplates any suitable communication interface.

Bus 460 may include hardware, software, or both coupling components of computer system 400 to each other. In some embodiments, bus 460 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 460 may include one or more buses 212, where appropriate. Although this disclosure describes and illustrates a particular bus, this disclosure contemplates any suitable bus or interconnect.

The components of computer system 400 may be integrated or separated. In some embodiments, components of computer system 400 may each be housed within a single chassis. The operations of computer system 400 may be performed by more, fewer, or other components. Additionally, operations of computer system 400 may be performed using any suitable logic that may comprise software, hardware, other logic, or any suitable combination of the preceding.

Modifications, additions, or omissions may be made to the systems, apparatuses, and methods described herein without departing from the scope of the disclosure. The components of the systems and apparatuses may be integrated or separated. Moreover, the operations of the systems and apparatuses may be performed by more, fewer, or other components. One skilled in the art will also understand that system 100 can include other components that are not illustrated but are typically included with similar systems. Additionally, operations of the systems and apparatuses may be performed using any suitable logic comprising software, hardware, and/or other logic. As used in this document, “each” refers to each member of a set or each member of a subset of a set.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. An infrastructure disturbance reporting system comprising:
a sensor configured to detect and measure underground vibrations and communicate data about the measurements;
a network interface configured to receive a communication comprising measurement data corresponding to a vibration event at a first location and location data indicative of the first location; and
at least one processor communicatively coupled to one or more databases that is configured to execute an assessment engine that is configured to:
in response to receiving the communication, issue a first query to the one or more databases to identify a ticket of interest based at least on information from the communication and a date that the communication was received;
identify an area of interest based on the first location;
issue a second query to the one or more databases to identify at least a first utility within the area of interest; and
automatically generate a response directed to a contact associated with each identified utility upon determining that:
the first query did not identify the ticket of interest; or
the ticket of interest indicates a ticket disturbance type that does not correspond to a detected disturbance type indicated in the communication.

2. The infrastructure disturbance reporting tool-system of claim 1, wherein the assessment engine is further configured to generate the response directed to each contact associated with the identified utilities upon determining that the communication comprises an indication of a safety hazard.

3. The infrastructure disturbance reporting system of claim 1, wherein determining whether to generate the response comprises:
comparing data indicated in the ticket of interest to data in the communication;
determining a confidence that the ticket of interest corresponds to the communication; and
comparing the determined confidence to a confidence threshold.

4. The infrastructure disturbance reporting system of claim 1, wherein the response comprises actuation of a valve of at least one of the identified utilities to a closed position.

5. The infrastructure disturbance reporting system of claim 1, wherein the response is generated within five minutes of the infrastructure disturbance reporting system receiving the communication.

6. The infrastructure disturbance reporting system of claim 1, wherein the response comprises deployment of an unmanned aerial vehicle over the area of interest, wherein the unmanned aerial vehicle comprises a camera.

7. The infrastructure disturbance reporting system of claim 1, wherein identifying the area of interest comprises determining and applying a radius around the first location, wherein the radius has a length up to 1000 feet.

8. The infrastructure disturbance reporting system of claim 1, wherein the assessment engine is further configured to identify the contact associated with each identified utility using a reference identifier corresponding to each identified utility.

9. A method for responding to infrastructure disturbances comprising:
receiving, from an external system communicatively coupled to one or more databases configured to store data about a plurality of tickets and a plurality of utilities, a first notification indicating an underground vibration event and a first location comprising a GPS coordinate corresponding to the underground vibration event, wherein the first notification comprises measurement information about the underground vibration event detected by one or more external sensors;
issuing a first query to one or more databases to identify a ticket of interest based at least on the first location and a date of the first notification;
identifying an area of interest by:
converting the GPS coordinate to a geographic point using a spatial reference identifier;
generating a buffer around the geographic point; and
converting the buffer to a shape;
issuing a second query to the one or more databases to identify a utility map comprising utility location information;
determining a first utility within the area of interest by overlaying the shape on the utility map; and
within five minutes of receiving the first notification, automatically generating a response directed to a contact associated with each identified utility upon determining that:
the first query did not identify the ticket of interest; or
the ticket of interest indicates a disturbance type that does not correspond to a detected disturbance type indicated by the measurement information.

10. The method of claim 9, further comprising:
generating a safety response directed to each contact associated with the identified utilities upon determining that the first notification comprises an indication of a safety hazard.

11. The method of claim 9, wherein determining whether to generate the response comprises:
comparing data indicated in the ticket of interest to data in the first notification;
determining a confidence that the ticket of interest corresponds to the first notification; and
comparing the determined confidence to a confidence threshold.

12. The method of claim 9, wherein the response facilitates actuation of a valve of at least one of the identified utilities to a closed position.

13. (canceled)

14. The method of claim 9, wherein identifying the area of interest comprises determining and applying a radius around the first location, wherein the radius has a length up to 1000 feet.

15. One or more computer readable non-transitory storage media embodying software that is operable when executed by at least one processor to:
receive, from an external system, a first notification indicating an underground vibration event and a first location corresponding to the underground vibration event, wherein the first notification comprises measurement information about the underground vibration event detected by the external system;
issue a first query to one or more databases configured to store data about a plurality of tickets and a plurality of utilities to identify a ticket of interest based at least on the first location and a date of the first notification;
identify an area of interest based on the first location;
issue a second query to the one or more databases to identify at least a first utility within the area of interest;
issue a second query to the one or more databases to identify at least a first utility within the area of interest; and
automatically generate a response directed to a contact associated with each identified utility upon determining that:
the first query did not identify the ticket of interest; or
the ticket of interest indicates a ticket disturbance type that does not correspond to a detected disturbance type indicated by the measurement information.

16. The media of claim 15, wherein the software is further configured to generate the response upon determining that the first notification comprises an indication of a safety hazard.

17. The media of claim 15, wherein determining whether to generate the response comprises:
comparing data indicated in the ticket of interest to data in the first notification;
determining a confidence that the ticket of interest corresponds to the first notification; and
comparing the determined confidence to a confidence threshold.

18. The media of claim 15, wherein the response facilitates actuation of a valve of at least one of the identified utilities to a closed position.

19. The media of claim 15, wherein the response comprises deployment of an unmanned aerial vehicle over the area of interest, wherein the unmanned aerial vehicle comprises a camera.

20. The media of claim 15, wherein identifying the area of interest comprises determining and applying a radius around the first location, wherein the radius has a length up to 1000 feet.

21. The media of claim 15, wherein the notification further comprises a GPS coordinate and the media is further operable to:
identify the area of interest by:
converting the GPS coordinate to a geographic point using a spatial reference identifier;
generating a buffer around the geographic point; and
converting the buffer to a shape; and
issue a second query to the one or more databases to identify at least the first utility within the area of interest by:
identifying a utility map comprising utility location information; and
overlaying the shape on the utility map.
